(19) United States
(12) Patent Application Publication
(10) Pub. No.: US 2008/0270221 A1
(43) Pub. Date: Oct. 30, 2008

(54) DETERMINING AND PRESENTING PRODUCT MARKET PRICES

(75) Inventors: Daniel James Clemens, Deer Harbor, WA (US); Scott Joseph Bean, Seattle, WA (US); Steven John Malloy, Redmond, WA (US); Steven Allen Hull, Snoqualmie, WA (US); Kurtis Reed Bray, Mercer Island, WA (US)

Correspondence Address: BLACK LOWE & GRAHAM, PLLC, 701 FIFTH AVENUE, SUITE 4800, SEATTLE, WA, 98104, US

(73) Assignee: Silvaris Corporation, Bellevue, WA (US)

(21) Appl. No.: 11/959,366

(22) Filed: Dec. 18, 2007

Related U.S. Application Data
(60) Provisional application No. 60/870,597, filed on Dec. 18, 2006.

(51) Int. Cl. G06Q 10/00

(52) U.S. Cl. 705/10

(57) ABSTRACT

A system includes an electronic device coupled over a network to first and second computing devices. The electronic device is configured to serve to the first computing device a first web page displayable on a display device. The displayed first web page includes a user interface operable to solicit from an individual of a plurality of individuals a current prediction of a plurality of current predictions of market prices of a product. The electronic device is further configured to determine an accuracy rating for each individual of the plurality based on a correlation between previous predictions provided by each said individual and actual market prices of the product. The electronic device is further configured to assign to the product a price estimate associated with a first predetermined time interval, the price estimate being a function of the accuracy ratings and current predictions. The electronic device is further configured to determine a current sale price based on the assigned price estimate. The electronic device is further configured to effect, via a second web page, a sale transaction of the product at the current sale price.

### PRIORITY CLAIM

This application claims the benefit of and priority to U.S. Provisional Patent Application Ser. No. 60/870,597 filed Dec. 18, 2006, which is incorporated by reference herein in its entirety.

### BACKGROUND OF THE INVENTION

Committing to a purchase price for a product or commodity by a purchaser often has major ramifications to the operation of a business, especially when product or commodity prices are susceptible to significant price variations. Knowing a predicted price by a given date or across a date range would benefit a purchaser by being able to make an informed decision. There is a need to reduce price uncertainty for products.

### SUMMARY OF THE INVENTION

In an embodiment of the invention, a system includes an electronic device coupled over a network to first and second computing devices. The electronic device is configured to serve to the first computing device a first web page displayable on a display device. The displayed first web page includes a user interface operable to solicit from an individual of a plurality of individuals a current prediction of a plurality of current predictions of market prices of a product. The electronic device is further configured to determine an accuracy rating for each individual of the plurality based on a correlation between previous predictions provided by each said individual and actual market prices of the product. The electronic device is further configured to assign to the product a price estimate associated with a first predetermined time interval, the price estimate being a function of the accuracy ratings and current predictions. The electronic device is further configured to determine a current sale price based on the assigned price estimate. The electronic device is further configured to effect, via a second web page, a sale transaction of the product at the current sale price.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a screenshot depiction of a version of the LumberSpace website interface;

FIG. 4 is a screenshot depiction of a version of a market forecast email having intelligent market predictions offered by a collection of participants for a set of products; and

FIG. 5 illustrates a process according to an embodiment of the invention.

### DETAILED DESCRIPTION OF THE PREFERRED EMBODIMENT

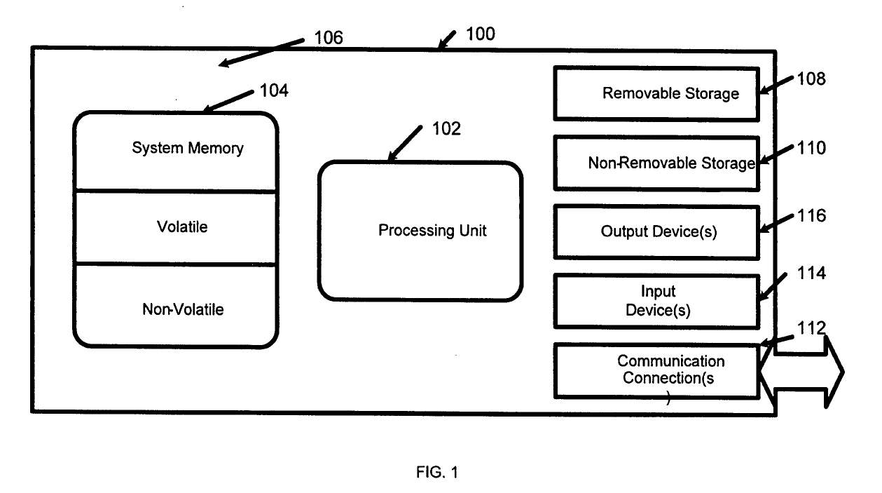

FIG. 1 illustrates an example of a computing system environment 100 in which an embodiment of the invention may be implemented. The computing system environment 100, as illustrated, is an example of a suitable computing environment; however it is appreciated that other environments, systems, and devices may be used to implement various embodiments of the invention as described in more detail below.

Embodiments of the invention are operational with numerous other general-purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed computing environment, program modules may be located in both local and remote computer storage media including memory storage devices.

With reference to FIG. 1, an exemplary system for implementing an embodiment of the invention includes a computing device, such as computing device 100. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

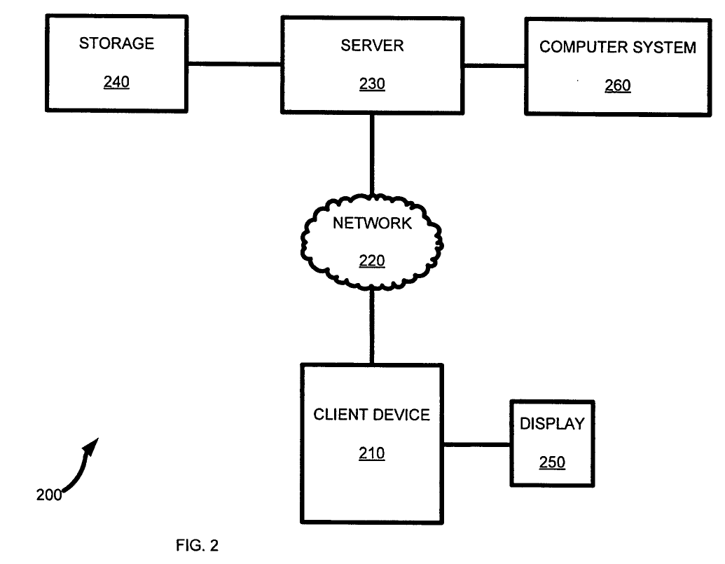

Referring now to FIG. 2, an embodiment of the present invention takes the form of an exemplary computer network system 200. The system 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to an electronic storage device 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210 and the server 230 may include all or fewer than all of the features associated with the device 100 illustrated in and discussed with reference to FIG. 1. The client device 210 includes or is otherwise coupled to a computer screen or display 250. The client device 210 may be used for various purposes such as network- and local-computing processes.

The client device 210 is linked via the network 220 to server 230 so that computer programs, such as, for example, a browser, running on the client device 210 can cooperate in two-way communication with server 230. The server 230 may be coupled to storage 240 to retrieve information therefrom and to store information thereto. Additionally, the server 230 may be coupled to the computer system 260 in a manner allowing the server to delegate certain processing functions to the computer system.

Still referring to FIG. 2, and in operation according to an embodiment of the invention, a user (not shown) of the client device 210 desiring, as discussed in further detail below, to provide a product price estimate and/or purchase the product uses a browser application running on the client device to access web content, which may, but need not, be served by the server 230. Specifically, by employing an appropriate uniform resource locator (URL) in a known manner, the user may navigate to a website hosted by the server 230.

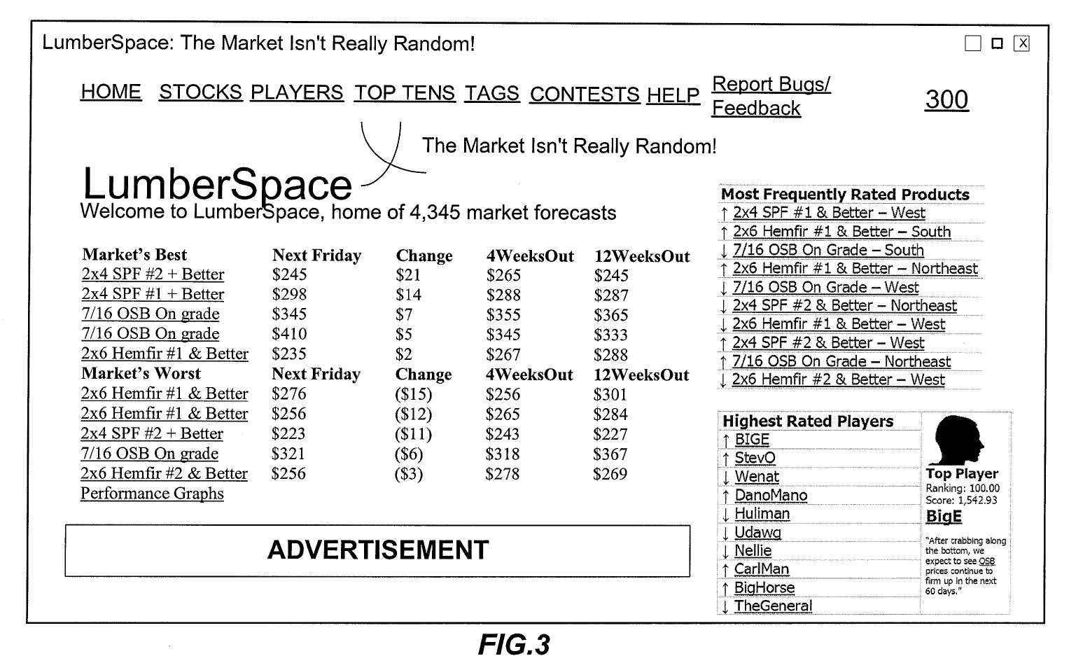

Upon navigating to the website, the user may be presented with a user interface 300 such as that illustrated in and described with reference to FIG. 3, for example, that may be displayed on the display device 250.

An embodiment of the invention relates generally to network- and Internet-based computer software and business systems and methods to facilitate the development of commercial markets using collective intelligence to determine, present, and set predicted market prices. Participants submit probability estimates for products on a timely and recurring basis to forecast the direction of established or the development of new markets. Users, subscribers, and/or licensees of the business system and method receive the benefit of knowing the predicted and dynamically updated product market prices for a given date and/or date range. Users, subscribers, and/or licensees also benefit from historical information detailing predicted pricing and indicating deviation from real market pricing.

As used herein, the term “product” could be defined as any of, but not necessarily limited to, the following:
An individual homogenous item, such as 2×4×8′ southern yellow pine lumber
An overall “quantity” of an item, such as a “truckload” of something
A time based delivery of an item, such as October/2009 delivery of 2×4×8′
A leveraged derivative of an item or combination of items, such as utilizing a unit measure of large quantity of items to be delivered in October/2009
A meaningful grouping of more than one homogenous item, such as a pallet kit
An associative grouping of more than one homogenous item, such as “plywood” where there may be thousands of different plywood items within the grouping
A composite of multiple individual items or groups which are utilized as a composite index to indicate pricing for a group of items. Wherein a composite could be comprised of items, groups or other composites
A composite or meaningful grouping of items that are used in a certain application, such as the “Homebuilders Index” where the items are specified in quantities/percentages that have some correlative relationship to the application
An individual, group or composite of items which have geographically differentiating characteristics. Such as “Homebuilders Index for the State of Texas”
An individual, group or composite of items which have logistically differentiating characteristics. Such as “Log bundles transportable only by ship”
An individual, group or composite of items which have weather or seasonal differentiating characteristics. Such as winter harvest of green hardwoods
An individual, group or composite of items which have disaster differentiating characteristics. Such as salvaged housing components from hurricane XYZ

Embodiments of methods and systems to facilitate or enable more convenient and efficient sale of inventory, by reducing transaction costs, employing computer software, remote communications and/or the Internet, are described herein.

An embodiment provides a website for forest-products buyers and sellers to predict product prices, monitor actual market pricing and consummate purchases of such products. With active participation, the price predictions will be highly representative of the actual prices paid in the marketplace.

One of the ways an embodiment can attract users may be to reward the best predictors with prizes. The site can also have compelling active content that attracts new participants and makes users want to often visit and interact with the site. Contributing to the site will be easy, and market information can be meaningful and readily available—for free and in real time.

The ease of use, rewards, and valuable information provided by an embodiment will attract a large online base of lumber industry users that will allow an embodiment to become an authoritative price reference for the marketplace. Over time, the developed user base can be monetized and expanded—a community.

It may be advantageous to segment user types by category so data can be analyzed at separate points in the sales/distribution channel, so that prices reported are relevant to users at their point in the channel. For example, a small retail buyer wants to see prices that make sense in the context of his buying from a co-op or lumber dealer, while a buyer for a hardware retailer may be buying direct from lumber mills. Each of these two users needs to understand what the “price” is and where that price is sampled. If an embodiment reports two prices, or a price clearly understood as “mill direct,” both users can derive their ultimate prices. An embodiment can algorithmically normalize price predictions across these various points.

Alternate embodiments might include procuring stumpage prices from landowners and other log dealers.

Over time, an embodiment gains the position as the user's best representation of the real market today, the trusted authority, with better, more timely data than any other source covering this market. Therefore it becomes for users a competitive advantage.

Embodiments may produce the following results:
Build a community of vendors/customers
Build a historical and accurate pricing matrix for a wide spectrum of forest-product types
Demonstrate a reliable pricing predictor for a variety of forest products
Become the de facto pricing/market metric
Produce a trading marketplace around the user community

Embodiments may include the following features:
Registration and use may be free
Users may be qualified and profiled upon registration
Site visitation may be motivated by compelling prizes/rewards for participation
Users may be compelled to return by valuable, higher quality, more timely data
User interface is simple—geared towards non-tech-savvy lumber industry
User community may be continuously involved, feedback is systematically incorporated
Store all bits of data for future analysis

In an embodiment, users may be actively engaged in commercial organizations that buy or sell wood products. Some types of users may be:
Mill sales and managers—primary producers of lumber and panels
End user customers (buyers of wood products)
Wholesalers and distributors (buyers and sellers) such as office wholesalers, stocking distributors, contractor yards, retailers
Secondary manufacturers (buyers and sellers)—manipulating lumber and panels to ready-made components—may include remanners and treaters
Observers—another class of industry participants that includes forest-products teachers and students, corporate researchers, financial analysts, and media personnel

These categories may be catalogued and profiled when users register to participate in an embodiment. It may be advantageous to capture each user's position in the sales/distribution channel to gain perspective on the prices they may enter. The measuring point in the channel may influence the weighting assigned to a given user's pricing predictions and/or accuracy rating.

Additionally, and as otherwise alluded to herein, the distribution chain of a commodity may contain numerous transfers of title, purchase points, sale points, and in general multiple custodies that occur throughout the chain.

These various points within the chain have a relationship which can be extrapolated based on other known or learned factors including, but not limited to, geographical regional considerations, prediction of prices by users throughout the chain, historical data, actual transactional information, volumetric sales information and collection of data from users of the system.

The knowledge collected from the various sources can be utilized to extrapolate and predict a price at a point within the distribution chain from which the system may not have enough direct predictions or historical information to accurately predict. Further, the knowledge collected will provide data which can be utilized to determine margin and profit percentages for the various intermediaries in the distribution chain and this secondary information could further be used to anticipate market pricing fluctuations—that is that as margins within a particular segment of the distribution chain fluctuate, there may be correlative market pricing effects which can be anticipated as a result of those margins fluctuating.

Through the user's profile and other means, the system will be able to determine where in the distribution chain the user is predicting pricing. The user may enter a prediction based on the type of shipping involved—FOB Mill for example—which will indicate that the pricing model being predicted is for a product which is being shipped direct from the mill to the end consumer. The user may be an intermediary (broker) or the mill or the end consumer—by utilizing the profile of the user, a further differentiation can be made and the prediction can be placed more accurately within the distribution chain.

As an example, assume there are three points within a distribution chain: a lumber mill, a lumber broker, and the final consumer. The lumber mill would sell the lumber at a lower price to the broker than the broker sells it to the final consumer. Thus there is potentially profits/markup (and possibly losses) in the distribution chain. Now contemplate a region where there are five lumber mills, two lumber brokers and ten final consumers. If the system has collected predictions or actual transactional pricing from four of the lumber mills and six of the final consumers some extrapolation can be made as to the price at which two lumber brokers are buying and selling, at what price the fifth lumber mill is likely to sell, and at what price the other four final consumers are likely to be buying.

FIG. 3 illustrates a screenshot depicting an embodiment of the website interface 300. The functions of the interface may be to provide:
a home page that may compel user registration and get users motivated to participate;
registration and profiling of the user for data analysis
ability for the user to enter product-price predictions
results and rankings of predicting users

The home page may describe the purpose of the website and provide a login area. The home page may provide rankings of predictions sortable by players/participants, products and price indicators. The home page may provide offers that motivate participation, such as rewards and prizes. The home page may provide rankings of player scores and recognition of top players. The home page may further provide suggestions for new products to price. The home page may provide product search functionality. Such search functionality may be facilitated by freeform text or using methodology described in commonly owned U.S. patent application Ser. No. 11/329,414 (Atty. Docket No. SILV-1-1004) which is herein incorporated by reference in its entirety. Entries could be logged for analysis by an administrator of the website. The home page may provide current and historical information about price changes in certain products. The home page may provide a view of pricing as related to sales channel so as to provide price predictions by users stationed at different points in the channel. The home page may further provide subscription options to allow users to receive emailed information. The home page may provide advertisements and/or other sponsorship opportunities.

In an embodiment, ads can serve as a component, at least, of a “bid/ask” system wherein people are “willing to sell” or “willing to buy” at a given price. This literally builds a bid/ask market and the pricing quoted could be considered a predictive data point or at least a factor in the overall prediction mechanism.

Additionally, the ad system could be structured to record the actual sale price of the item/product—thus providing the data point of the transaction in addition to the derivative value of the negotiated price from the original bid/ask.

Additionally, if an auction system is placed along with the ad system—wherein products get auctioned—the same information about the final pricing, bid activity, etc. would be very relevant in the overall prediction mechanism.

An embodiment may require a license agreement to be accepted by the user to participate. The user may also be asked to enter certain details such as company name, email address, physical address, telephone and fax numbers, shipping locations, websites, requested password, and/or business types. As discussed elsewhere herein, this sort of information will be advantageous to capturing the position in the distribution chain at which the user is buying/selling in order to analyze their input price data appropriately.

In an embodiment, the user may select from a list of products displayed in a web page for which they would like to give pricing predictions. The product listing may be provided by an administrator of the website and/or may include products suggested by users. The user may be able to search for products by entering keyword and/or select products from a list of selectable items. Over time, the products list may be entirely generated by users. Moreover, product types may include products that could be described as proprietary composites of other more typical or standard product types, such as secondary manufactured products.

For navigation purposes, the site may display a hierarchy of categories that define products in a meaningful way for the forest products industry. Some examples of categories may include:
Lumber—dimension, shop, boards
Panels—OSB, plywood, particle board
Hardwood—cut stock, crane mats

Product location is an attribute of the product and control of the price. In an embodiment, one way to define regions is to regionalize products to defined locations that are common zones, such as, but not limited to, the following:
Canada—West, Central, East, North
USA—Alaska, Northwest, Southwest, North Central, South Central, North East, Mid Atlantic, Mid West, Southeast
Mexico—Northwest, Northeast, Central, South

In an embodiment, profiled buyers make entries predicting buying prices for a particular product at a predetermined time in the future. Additionally, profiled sellers make entries predicting selling prices for a particular product at a predetermined time in the future. Users profiled as both buyers and sellers may enter both pricing types. As alluded to elsewhere herein, user profiles define where in the distribution chain they buy or sell. Moreover, all users may be measured on price point predictions as well as fluctuation (up or down) predictions.

An embodiment provides one or more contests to reward those users whose predictions are most accurate over a predetermined time interval. Some such predictive contests could be optional and accessed by user signup. One example of such a game would be a contest where a user makes predictions further away in time than the standard contests.

In an embodiment, timing is an important component in when predictions are made. The relationship between the time the prediction was made and the actual price knowledge is a significant factor in the weighting of the player's prediction. Some timing components of an embodiment that can score predictions could include, but are not limited to:

Time is relative and date-based

Earlier predictions as related to actual pricing carry more weight than predictions closer in time to actual pricing

Sporadic participation can be allowed for

Predictions can be added to or otherwise modified

Options for scoring or otherwise valuing predictions may include:
Correlate the score to mean prediction, weighted to user's ranking
Correlate the score to other price-publisher data or some proprietary derivative of them
Ask price at the time of prediction, mean becomes the accurate answer

In an embodiment, player ranking could be based on the player's successful predictions in measurable time periods. Additionally, best predictors can receive the highest numerical scores. Simple numerical scores may be displayed, but more information about periodic performance could be available somewhere in the website, as well (e.g., via clicking through a player's name). A user changing a prediction could cause diminution of the overall ranking of the user.

As alluded to elsewhere herein, users can submit descriptions of new products for consideration in connection with the website. If other users enter the same products, the list of commonly requested products could be displayed and a user could add their vote to promote the product to one used in contests.

An embodiment may include a shareable public profile containing information about the user such as contact information, picture, company, website links. Such a profile could be used as a type of sales page for the user. The page could be assigned a recognizable URL that the user could send to others and thereby drive more visitors to the site.

An embodiment may include a blog, moderated by an administrator of the website, for players to engage in discussions about the site and related topics with each other.

An embodiment may include a web form that a user could fill out to send to a prospective new participant. Additionally, an embodiment may include a web form that users can use to send new ideas about the site and related topics to an administrator of the website.

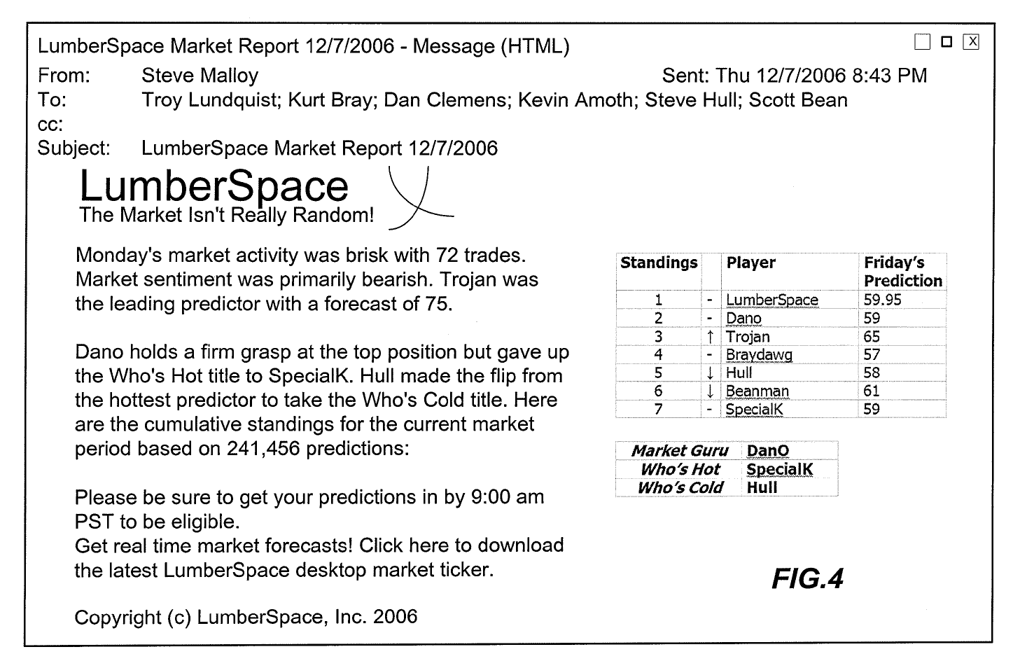

FIG. 4 illustrates a screenshot depicting one possible type of market forecast email having intelligent market predictions offered by a collection of participants for a set of products. Email communications could be sent at regular intervals, for a variety of purposes, and be able to be forwarded to other potential participants who are not currently registered on the site. Email communications could also contain links to direct users to the site. Possible types of email messages could include:
Reminders to submit predictions
Alerts about contests coming to an end or already completed
Periodic informative industry information
Special promotions
Alerts about user's performance in different contests
Changes to the site

Other forms of communication to users could be used in addition to email, such as fax. In an embodiment, users would be allowed to opt out of receiving any types of communication.

An embodiment could include a system where suppliers can store information related to their own business partners, such as contact names, company names, email addresses, phone and fax numbers, addresses in, for example, the storage 240. Suppliers could use the information as a lightweight database to communicate with business partners.

Suppliers could input information related to their on-hand inventory, even manage specific units of inventory, using an embodiment.

Suppliers could manage orders generated by customers from inventory they have uploaded to an embodiment of the system. Order-related documentation, sales reports, data export, etc. could be available to suppliers.

An embodiment could include features that provide various marketing type services to both buyers and sellers. Examples of such services could include email and fax offerings tools, and/or supplier websites, including online buying opportunities.

An embodiment could provide links or integration with other service providers or itself for such services as:
Credit information
Logistics and transportation services
Trading/wholesaling services
Technology consulting services

Customer features could be dependent on supplier contributions to marketplace.
Billing system for fee-based services
Calculators, wood products converters, currency converters
Searching for available supplier offerings
Unified view of various services, such as offerings and transaction services
Industry and Economy news and information
Localization for other languages
Support for international business
Hosting for private contests such as one designed by a specific company, or contests within segments of the industry
Multimedia features such as soundtracks or avatars

An embodiment can include a method of predicting prices in various currencies by normalizing currency valuations as predictions are provided by participants.

An embodiment can include a method of predicting prices in different regions, including:
Calculating prices based on delivery locations;
Using multiple factors, such as geographic considerations, transportation service availability, customer and supplier locations, product types, etc. to define significant regions;
Normalizing price predictions such that delivery considerations (i.e., customer pickup vs. supplier delivery) are not a differentiating factor.

An embodiment can include a method of creating composite (e.g., two different types of product bundled into one) price predictions for various types of buyers by combining individual product price predictions into meaningful price composites, the aggregate predicted prices of which are derived from individual product elements and weighted by participants who commonly agree to relevant definitions of composites.

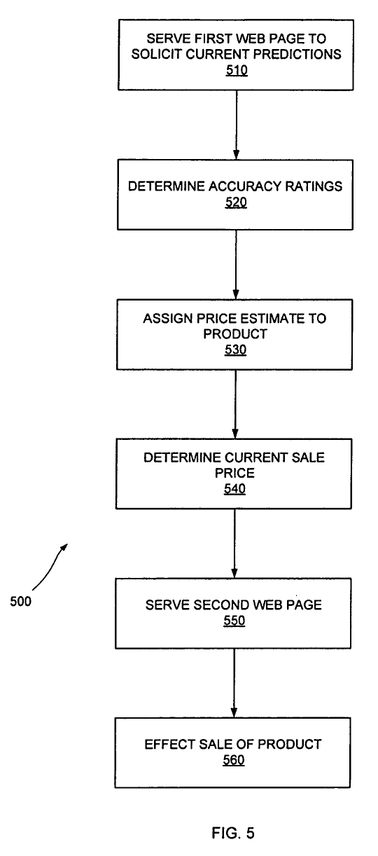

FIG. 5 illustrates a process 500 according to an embodiment of the invention. The process 500 may be implementable in an electronic system coupled over a network to first and second electronic devices, the electronic devices being coupled to respective display devices. The process 500 is illustrated as a set of operations shown as discrete blocks. The process 500 may be implemented in any suitable hardware, software, firmware, or combination thereof. The order in which the operations are described is not to be necessarily construed as a limitation.

At a block 510, a first web page displayable on a display device is served to the first electronic device. The displayed first web page can include a user interface operable to solicit from an individual of a plurality of individuals a current prediction of a plurality of current predictions of market prices of a product. The predictions may be associated with a first predetermined time interval. For example, the interface 300 served by the server 230 may include a data entry field (not shown) that will enable a user to enter a value serving as a predicted unit sale price for a product on a date two weeks, for example, in the future.

At a block 520, an accuracy rating for each individual of the plurality is determined based on a correlation between previous predictions provided by each said individual and actual market prices of the product. For example, the server 230 and/or computer system 260 may consult the storage device 240 to compare previous price predictions submitted by a user with the actual historic market price corresponding to the dates associated with such previous predictions. The server 230 and/or computer system 260 may then calculate an accuracy rating value for the user based on the extent to which the previous price predictions match or approach the actual historic market prices.

Weighting of a user's rating may be affected by their accuracy and timeliness of predicting multiple products potentially within a group of products that may or may not be related.

As an example, a user may make multiple predictions on multiple grades/sizes/types of plywood. Each of these grades/sizes/types of plywood would be considered a product and while a plurality of predictions could be made individually on each product, the accuracy of the predictions on “related” products could be influential on the prediction accuracy of an individual product. A user may make 100 predictions each on 3 different types of plywood—(3 products that are related by group or classification)—the user may then begin making predictions on a 4th product (yet another type of plywood) and the system could then utilize the user's accuracy in the previous 300 predictions to favorably weight the user's accuracy at estimating within this group of products. However, if the user begins making predictions on a 4th product that is outside the group of plywood, the system may give weight only to the user's frequency, accuracy, timeliness and so forth since the new predictions are outside the group of plywood.

At a block 530, a price estimate associated with the first predetermined time interval is assigned to the product. The price estimate may be a function of the accuracy ratings and current predictions. For example, the server 230 and/or computer system 260 may calculate a price estimate as an average of the current predictions of the users, each of which is weighted according to the corresponding accuracy rating associated with a respective particular user. In an embodiment, a set of actual prices associated with actual bids for the product during a second predetermined time interval may be retrieved from the storage 240 or other memory device accessible to the server 230. The price estimate may further be a function of the actual-price set.

Additionally, in an embodiment, the current predictions may be segregated into a first type made by individuals of the plurality who are product buyers and a second type made by individuals of the plurality who are product sellers. Moreover, the current predictions may be segregated into a third type made by individuals of the plurality who provide the product from a first point in a distribution chain of the product and a fourth type made by individuals of the plurality who provide the product from a second point in the distribution chain of the product. For example, the server 230 and/or computer system 260 can segment user types by category so data can be analyzed at separate points in the sales/distribution channel, so that prices reported are relevant to users at their point in the channel. For example, a small retail buyer wants to see prices that make sense in the context of his buying from a co-op or lumber dealer, while a buyer for a hardware retailer may be buying direct from lumber mills.

Additionally, in an embodiment, the current predictions may be segregated into a first type associated with sales of the product involving a party in a first geographical region and a second type associated with sales of the product involving a party in a second geographical region. For example, the server 230 and/or computer system 260 can segment price predictions by geographic region of the seller and/or the potential buyer and adjust such predictions by inflation factors associate with each such respective region. In the case of each such embodiment, the price estimate may further be a function of the prediction type.

At a block 540, a current sale price based on the assigned price estimate is determined. For example, the server 230 and/or computer system 260 may assign a sale price to a product that is higher, lower or equal to the price estimate and display such sale price in the interface 300. In an embodiment, a rate of stability of predicted price is determined based on a correlation between previous of the price estimates and actual market prices of the product. For example, the server 230 and/or computer system 260 can determine a multiplier reflective of the extent to which previous price estimates have matched or approached actual prices and use such multiplier to adjust the price estimate up or down. As such, the determined current sale price may be a function of the determined stability rate.

At a block 550, a second web page displayable on a display device is served to the second electronic device. Such a web page may include a price, which may be the price estimate, at which a viewer of the second web page may purchase the product. For example, the interface 300 served by the server 230 may include such a price and data entry fields (not shown) enabling the user to enter the information necessary to purchase the product at the price.

At a block 560, a sale transaction of the product at the current sale price is effected via the second web page. For example, the server 230 and/or computer system 260 may consummate the purchase of the product at the sale price.

While the particular embodiments have been illustrated and described, many changes can be made without departing from the spirit and scope of the invention. For example, the particular embodiments may further include transactions conducted by non-Internet procedures and systems. Similarly, the product definitions used need not be generated by the program instructions attached as in the above appendix, but may be supplied by other means. Similarly, while the described system is especially useful in the context of lumber, and for sake of simplicity many of the examples have been drawn from that industry, any goods or services are amenable to use by various embodiments of the invention. Alternate embodiments of the described invention present methods of buying from a seller such as: providing the seller use of database software for managing the seller's inventory, accessing information through a computer network about the seller's inventory managed by said software, and purchasing one or more items of said inventory. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer-readable medium having computer-executable instructions for performing steps comprising:
soliciting from a plurality of individuals a plurality of current predictions of market prices of a product, said predictions being associated with a first predetermined time interval;
determining an accuracy rating for each individual of the plurality based on a correlation between previous predictions provided by each said individual and actual market prices of the product;
assigning to the product a price estimate associated with the first predetermined time interval, the price estimate being a function of the accuracy ratings and current predictions;
determining a current sale price based on the assigned price estimate; and
effecting a sale transaction of the product at the current sale price.

2. The medium of claim 1 having further computer-executable instructions for determining a rate of stability of predicted price based on a correlation between previous of the price estimates and actual market prices of the product.

3. The medium of claim 2 wherein the determined current sale price is a function of the determined stability rate.

4. The medium of claim 1 having further computer-executable instructions for:
retrieving a set of actual prices associated with actual bids for the product during a second predetermined time interval; and
wherein the price estimate is further a function of the actual-price set.

5. The medium of claim 1 having further computer-executable instructions for segregating the current predictions into a first type made by individuals of the plurality who are product buyers and a second type made by individuals of the plurality who are product sellers, wherein the price estimate is further a function of the prediction type.

6. The medium of claim 5 having further computer-executable instructions for segregating the current predictions into a third type made by individuals of the plurality who provide the product from a first point in a distribution chain of the product and a fourth type made by individuals of the plurality who provide the product from a second point in the distribution chain of the product.

7. The medium of claim 1 having further computer-executable instructions for:
identifying a first currency in which a current prediction is made; and
normalizing the value of the first currency to a value of a second currency.

8. The medium of claim 1 having further computer-executable instructions for segregating the current predictions into a first type associated with sales of the product involving a party in a first geographical region and a second type associated with sales of the product involving a party in a second geographical region, wherein the price estimate is further a function of the prediction type.

9. A method implementable in an electronic system coupled over a network to first and second electronic devices, the electronic devices being coupled to respective display devices, the method comprising:
serving to the first electronic device a first web page displayable on a display device, the displayed first web page including a user interface operable to solicit from an individual of a plurality of individuals a current prediction of a plurality of current predictions of market prices of a product, said predictions being associated with a first predetermined time interval;
determining an accuracy rating for each individual of the plurality based on a correlation between previous predictions provided by each said individual and actual market prices of the product;
assigning to the product a price estimate associated with the first predetermined time interval, the price estimate being a function of the accuracy ratings and current predictions;
determining a current sale price based on the assigned price estimate;
serving to the second electronic device a second web page displayable on a display device; and
effecting, via the second web page, a sale transaction of the product at the current sale price.

10. The method of claim 9, further comprising determining a rate of stability of predicted price based on a correlation between previous of the price estimates and actual market prices of the product.

11. The method of claim 10 wherein the determined current sale price is a function of the determined stability rate.

12. The method of claim 9 further comprising:
retrieving a set of actual prices associated with actual bids for the product during a second predetermined time interval; and
wherein the price estimate is further a function of the actual-price set.

13. The method of claim 9 further comprising segregating the current predictions into a first type made by individuals of the plurality who are product buyers and a second type made by individuals of the plurality who are product sellers, wherein the price estimate is further a function of the prediction type.

14. The method of claim 13 further comprising segregating the current predictions into a third type made by individuals of the plurality who provide the product from a first point in a distribution chain of the product and a fourth type made by individuals of the plurality who provide the product from a second point in the distribution chain of the product.

15. The method of claim 9 further comprising:
identifying a first currency in which a current prediction is made; and
normalizing the value of the first currency to a value of a second currency.

16. The method of claim 9 further comprising segregating the current predictions into a first type associated with sales of the product involving a party in a first geographical region and a second type associated with sales of the product involving a party in a second geographical region, wherein the price estimate is further a function of the prediction type.

17. A system, comprising:
a memory device; and
an electronic device coupled to the memory device and coupled over a network to first and second computing devices, the computing devices being coupled to respective display devices, the electronic device configured to:
serve to the first computing device a first web page displayable on a display device, the displayed first web page including a user interface operable to solicit from an individual of a plurality of individuals a current prediction of a plurality of current predictions of market prices of a product, said predictions being associated with a first predetermined time interval;
determine an accuracy rating for each individual of the plurality based on a correlation between previous predictions provided by each said individual and actual market prices of the product;
assign to the product a price estimate associated with the first predetermined time interval, the price estimate being a function of the accuracy ratings and current predictions;
determine a current sale price based on the assigned price estimate; and
serve to the second computing device a second web page displayable on a display device.

18. The system of claim 17, wherein the electronic device is further configured to determine a rate of stability of predicted price based on a correlation between previous of the price estimates and actual market prices of the product.

19. The system of claim 18 wherein the determined current sale price is a function of the determined stability rate.

20. The system of claim 17 wherein the electronic device is further configured to:
retrieve a set of actual prices associated with actual bids for the product during a second predetermined time interval; and
wherein the price estimate is further a function of the actual-price set.

21. The system of claim 17 wherein the electronic device is further configured to segregate the current predictions into a first type made by individuals of the plurality who are product buyers and a second type made by individuals of the plurality who are product sellers, wherein the price estimate is further a function of the prediction type.

22. The system of claim 21 wherein the electronic device is further configured to segregate the current predictions into a third type made by individuals of the plurality who provide the product from a first point in a distribution chain of the product and a fourth type made by individuals of the plurality who provide the product from a second point in the distribution chain of the product.

23. The system of claim 17 wherein the electronic device is further configured to:
identify a first currency in which a current prediction is made; and
normalize the value of the first currency to a value of a second currency.

24. The system of claim 17 wherein the electronic device is further configured to segregate the current predictions into a first type associated with sales of the product involving a party in a first geographical region and a second type associated with sales of the product involving a party in a second geographical region, wherein the price estimate is further a function of the prediction type.

25. The system of claim 17 wherein the electronic device is further configured to effect, via the second web page, a sale transaction of the product at the current sale price.

26. A computer-readable medium having computer-executable instructions for performing steps comprising:
soliciting from a plurality of individuals a plurality of current predictions of market prices of a plurality of products, said predictions being associated with a first predetermined time interval;
determining an accuracy rating for each individual of the plurality based on a correlation between previous predictions provided by each said individual and actual market prices of the plurality of products;
assigning to a product of the plurality a price estimate associated with the first predetermined time interval, the price estimate being a function of the accuracy ratings and current predictions;
determining a current sale price based on the assigned price estimate; and
effecting a sale transaction of the product at the current sale price.
